(19) United States
(12) Patent Application Publication
(10) Pub. No.: US 2007/0127420 A1
(43) Pub. Date: Jun. 7, 2007

(54) Method, system and apparatus for creating a reverse tunnel

(76) Inventor: Paula Tjandra, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/293,921

(22) Filed: Dec. 5, 2005

(51) Int. Cl. H04Q 7/24

(52) U.S. Cl. 370/338; 370/401

(57) ABSTRACT

A method, system and apparatus for creating a reverse tunnel in a communication system is provided. The method includes obtaining an authentication key from an entity in the communication system. The method further includes manipulating a registration request message (402) sent by a mobile station (106) to a local agent (110) at an external agent (112) and re-calculating a digital signature of the registration request message using the authentication key. This manipulation is performed by using the authentication key. Thereafter, the registration request message is sent (516) from the external agent to the local agent for creating the reverse tunnel.

### FIELD OF THE INVENTION

The present invention relates generally to mobile communication, and more specifically, to the creation of reverse tunnels in a communication system.

### BACKGROUND OF THE INVENTION

The Internet is interconnections of mobile stations that enable its users to access information and communicate with other mobile stations. All mobile stations are identified by a globally routable address. Internet Protocol (IP) addressing is used to allocate globally routable address to a mobile station. A globally routable address is generated based on the mobile station's point of attachment. Further, each mobile station is a computational device that can be stationary (for example, a desktop computer) or mobile (for example, a laptop computer or a mobile phone).

A mobile station can be a migratory node that moves from one fixed network to another but utilizes the Internet only when physically connected to any communication network. A mobile station can also be a roaming node that can maintain a connection to the Internet, even while it is moving from one fixed communication network to another. These communication networks may or may not be present in different communication networks. For example, a laptop is connected through a Wireless Fidelity (WiFi) network to the Internet and then the laptop switches to another WiFi network. Another example may be a mobile station such as a cell phone that moves from one communication network of General Packet Radio Service (GPRS) connectivity to another communication network.

Communication between mobile stations is not addressed by the conventional IP addressing scheme. A separate scheme, Mobile IP, allows a mobile station to be identified by a single address, known as the home address, regardless of its current physical point of attachment. The usage of the home address makes mobility transparent to applications and makes it appear that the mobile station is continually able to receive data on its home network. To enable this, the networked environment is divided into distinct networks, foreign (or external) network and home (or local) network. The foreign network is defined as the network where the mobile station is currently located. The home network is defined as the network which assigns the mobile station's home address. A foreign network could have one or more foreign agents (or external agents). The foreign agent monitors the mobile stations visiting that foreign network. Further, each home network has a home agent (or a local agent) that monitors the mobile stations that are associated with the home network, and are currently visiting other (foreign) networks.

When a mobile station is not attached to its home network, the home agent is responsible for delivering all traffic destined for the mobile station to the mobile station's current point of attachment. Another address, known as a Care-of Address (COA), is used to identify the mobile station's current point of attachment with respect to the network topology. Whenever the mobile station changes its point of attachment, it registers its new Care-of Address with its home agent. There are two different types of Care-of Address: Foreign Agent Care-of address and co-located Care-of Address. Foreign Agent Care-of Address is an address of a foreign agent with which the mobile station is registered attached to. Co-located care-of address is an address assigned solely to the mobile station from the foreign network. In other words, the co-located care-of address is an externally obtained local address which the mobile station has attached with one of its own network interface.

Mobile IP assumes that all nodes in the Internet have addresses that are within the same globally routable address space. However, with the number of mobile stations exceeding the number of addresses available, service providers assign a private or disparate IP address to the mobile stations. The mobile station with a private IP address or disparate IP address may visit a communication network where its address is not routable, since a private address is not routable in a public domain, but is routable only in the private domain. Consequently, data packets addressed to the mobile station would not reach it. The concept of private IP address allocation is defined in RFC1918 (Rekhter, et al.,“Address Allocation for Private Intemets”). A private IP address is not routable in the public network but permits full network layer connectivity among all devices inside an enterprise. The advantage of using private address space is to conserve the globally unique address space by not using it where global uniqueness is not required. The concept of a disparate IP address is often used in corporations which have several properly allocated address ranges. They advertise reach-ability to only a subset of those ranges, leaving the others for use exclusively with the corporate network. Since these ranges are not routable in the general Internet, their use leads to the same problems encountered with the private IP addresses, even though they are not taken from the ranges specified in RFC 1918.

To solve this problem, a tunnel is created from the local agent to the care-of-address of the mobile station. Another problem arises when the mobile station tries to communicate with another mobile station (with a private or disparate address) in the mobile station's home network. However, the current protocol for reverse tunneling solution implicitly assumes that all mobile stations are capable of obtaining reverse tunnel through Mobile IP registration request message. Further, many legacy mobile stations do not support this feature and would need to be upgraded or replaced.

### BRIEF DESCRIPTION Of THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of an abstract model of a communication system supporting communication of mobile station across different networks, in accordance with one embodiment of the invention.

FIG. 2 is an example of an external agent in accordance with one embodiment of the invention.

FIG. 3 is an example of a local agent in accordance with one embodiment of the invention.

FIG. 4 is an example of a registration request message in accordance with one embodiment of the invention.

FIG. 5 and 6 are exemplary process flow diagrams illustrating a method for communication between mobile stations in accordance with one embodiment of the invention.

FIG. 7 represents a block diagram for an apparatus for creating a reverse tunnel in a communication system, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

Before describing in detail the embodiments in accordance with the present invention, it should be observed that the embodiments reside primarily in combinations of method steps and apparatus components related to communication between mobile stations. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms“comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A“set”, as used in this document, means a non-empty set (i.e., comprising at least one member). The term“another”, as used herein, is defined as at least a second or more. The terms“including” and/or“having”, as used herein, are defined as comprising. The term“coupled”, as used herein with reference to electro-optical technology, is defined as connected, although not necessarily directly, and not necessarily mechanically. The term“program”, as used herein, is defined as a sequence of instructions designed for execution on a computer system. A“program”, or“computer program”, may include a subroutine, a function, a procedure, an object method, an object implementation, an executable application, an applet, a servlet, a source code, an object code, a shared library/dynamic load library and/or other sequence of instructions designed for execution on a computer system.

A method and system for creating a reverse tunnel in a communication system is disclosed. The communication system includes at least one mobile station and a plurality of networks. The reverse tunnel is created from an external agent, in a first network of the communication system, to a local agent of a second network of the communication system. An authentication key is obtained from an entity in the communication system. The external agent manipulates a registration request message sent by a mobile station to the local agent and re-calculates a digital signature of a modified registration request message using the authentication key. The registration request message is sent to the local agent to create the reverse tunnel.

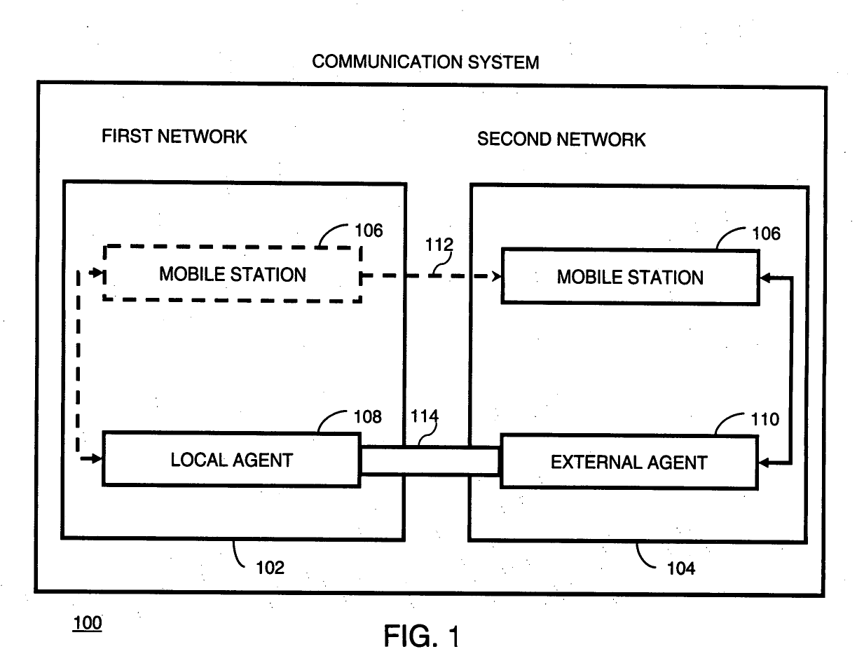

FIG. 1 is an example of an abstract model of a communication system 100 supporting communication of mobile station across different networks, in accordance with one embodiment of the invention. The communication system 100 is divided into a number of distinct networks. For example, the communication system 100 includes a first network 102, a second network 104. Examples of the first network 102 and the second network 104 include GPRS, WiFi, Worldwide Interoperability for Microwave Access (Wi-MAX), Enhanced Data for GSM Evolution (EDGE), Evolution Data Only (EVDO), Evolution Data Voice (EVDV), wireless communication standards from IEEE such as 802.11a, 802.11b, 802.11g, and the like. The first network 102 includes a mobile station 106 and a local agent 108. The second network 104 includes an external agent 110. In one embodiment, when the mobile station 106 moves from the first network 102 to the second network 104, as shown by dotted line 112. The mobile station 106 associated with the local agent 108 (in the first network 102) moves to the second network 104 and is now associated the external agent 110.

In one embodiment of the present invention, the mobile station 106 is a mobile phone. Exemplary mobile stations include cellular phones which are capable of requesting and obtaining a reverse tunnel, and are compliant with Request for Comments (RFC) 3344 and RFC 3024 published by the Internet Engineering Task Force (IETF). The external agent monitors the mobile stations visiting the network associated with it. The local agent on the other hand serves as a home serving site for a mobile station associated with it. For example, the external agent 110 monitors mobile stations visiting networks that are associated with the external agent 110, while the local agent 108 monitors the mobile stations that are associated with it, and are visiting other networks. These other networks may or may not be associated with the external agent 110. The communication of mobile station 106 across the first network 102 and the second network 104, takes place through a path called a tunnel. For example, a tunnel 114 is formed between the local agent 108 and the external agent 110. A tunnel starts sending the packets at a local agent and ends at a care-of address of the mobile station. For example, the tunnel 114 starts sending the packets from the local agent 108 (in the first network 102) to the external agent 110 (in the second network 104). On the other hand, a reverse tunnel starts sending the packets at the care-of address of a mobile station and terminates at the local agent of the mobile station. For example, the tunnel 114 starts sending the packets from the external agent 110 (in the second network 104) to the local agent 108 (in the first network 102).

Further, the local agent 108 also forwards all data packets addressed to a mobile station that is currently visiting a different network to its care-of address or a co-located care-of address. The care-of-address may be the address of an external agent with which the mobile station is currently associated. A co-located care-of address is an externally obtained local address which the mobile station has associated with one of its own network interface. In other words, the co-located care-of address is an address assigned solely to the mobile station from the external agent. The external agent 110 and the local agent 108 exchange data packets with each other using the tunnel 114. A two-way communication channel also exists between the external agent 110 and the mobile station 106. The communication system further includes other computational devices and mobile stations, which can exchange data packets with one another.

In various embodiments of the present invention, the local agent 108 is a router associated with the mobile station 106 that tunnels data packets to the mobile station 106 when it is visiting other networks. The external agent 110 can also be a router in a network that is being visited by the mobile station 106. The external agent 110 terminates the tunnel between the local agent 108 and the mobile station's care-of-address. Further, the external agent 110 also sends the data packets destined for the mobile station 106 and sent by the local agent 108. Also, the external agent 110 serves as a default router for any data packets that are sent by the mobile station 106 to any other network.

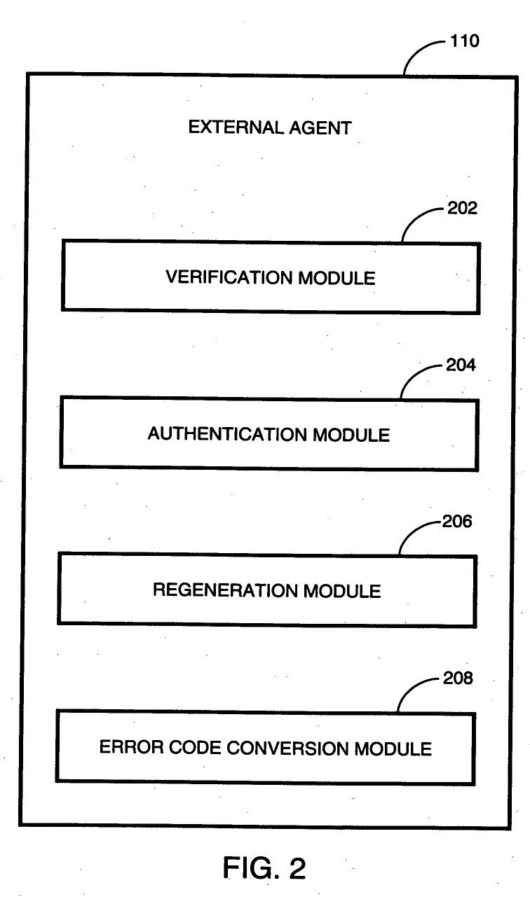

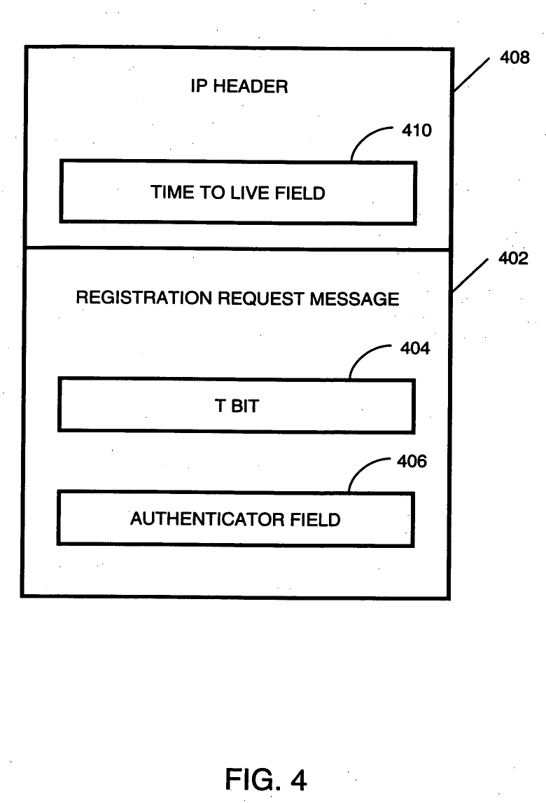

FIG. 2 is an example of an external agent 110 in accordance with one embodiment of the invention. The responsibilities of the external agent 110 include setting the value of at least one bit in a registration request message to be sent to the local agent 108. The external agent 110 includes a verification module 202, an authentication module 204, a regeneration module 206, and an error code conversion module 208. The verification module 202 authenticates the mobile station 106. In other words, the verification module 202 provides a care-of-address to the mobile station 106. The authentication is performed when the mobile station 106 is entering the second network 104 monitored by the external agent 110. Once the mobile station 106 has been authenticated, the authentication module 204 obtains a mobile Internet protocol (IP) mobile station 106—local agent 108 authentication key from various sources in the communication system 100. Exemplary sources from where the mobile IP authentication key may be obtained are the local agent 108, an authentication authorization and accounting (AAA) server of the local agent 108, and from any other database containing the mobile IP authentication key. In another embodiment of the present invention, various other authentication keys may be used by the verification module 202. The mobile IP authentication key is used by the external agent 110 to regenerate (or modify) an authenticator field in a registration request message. The authenticator field is generated using the mobile IP authentication key. The registration request message is to inform the local agent 108 of the care-of address of the mobile station 106 by registering with the external agent 110. In accordance with an embodiment of the present invention, the authenticator field is generated using an algorithm such as a keyed message digest (MD5) algorithm with the 128 bit mobile IP authentication key obtained by the authentication module 204. The mobile IP authentication key is used to calculate digital signature associated with the messages exchanged between the mobile station 106 and the local agent 108. The digital signature is calculated based on the registration request message and the mobile IP authentication key using the MD5 algorithm. This will be explained later in conjunction with FIG. 4.

The regeneration module 206 sets a bit pattern in the registration request message to request for the creation of a reverse tunnel. Further, the regeneration module 206 regenerates a digital signature, present in the authenticator field, to generate a mobile station 106—local agent 108 authentication extension for the modified registration request. The modified registration request message, with the modified authenticator field, is sent from the external agent 110 to the local agent 108 requesting for the creation of the reverse tunnel 114. The external agent 110 receives a reply to the registration request message. The reply is sent by the local agent 108 and pertains to the construction of a reverse tunnel. The reply may contain an error code, which may not be comprehensible to the mobile station 106. The error code conversion module 208 translates such error code and sends the reply to the mobile station 106. In one embodiment of the present invention, the reverse tunnel 114 is created based on the implementation of ingress filtering in the communication system 100. Ingress filtering ensures that data packets are not forwarded unless the source IP address in the network is topologically correct.

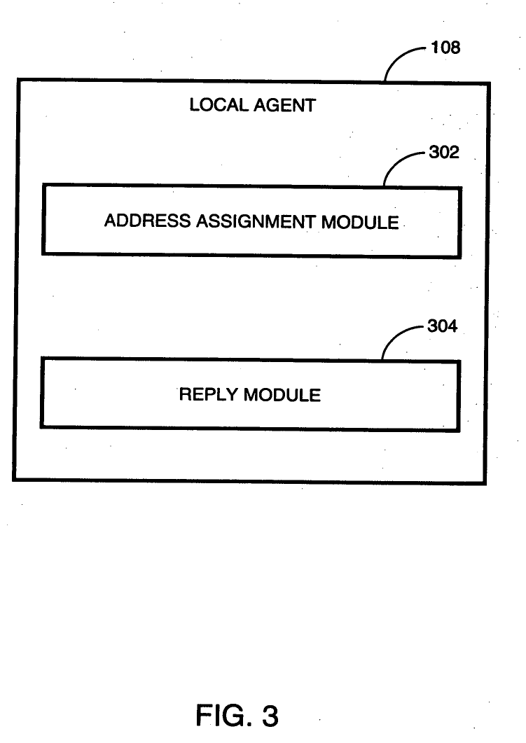

FIG. 3 is an example of a local agent 108 in accordance with one embodiment of the invention. The local agent 108 includes an address assignment module 302 and a reply module 304. The local agent 108 is responsible for keeping track of mobile stations that are associated with it, and are currently visiting other networks. The local agent 108 also forwards all data packets addressed to the mobile station 106, which is currently visiting a different network, to the care-of address of the mobile station 106. In one embodiment of the present invention, the address assignment module 302 could assign an address to the mobile station 106. The assigned address can be a private address or a disparate address and uniquely identifies the mobile station 106 to the local agent 108. The reply module 304 is responsible for replying to the registration request message sent by the external agent 110. In one embodiment of the present invention, the reply module 304 returns the reply as a rejection of the registration request message with the error code.

FIG. 4 is an example of a registration request message 402 in accordance with one embodiment of the invention. The mobile station 106 sends a registration request message 402 to the local agent 108 via the external agent 110. The purpose of sending the registration request message 402 is to inform the local agent 108 of the care-of address of the mobile station 106 by registering with the external agent 110. Successful registration establishes a mobility binding in the local agent 108 between the mobile station 106 and the care-of-address of the mobile station 106. The mobility binding is used by the local agent 108 to forward any traffic destined to the mobile station 106 to mobile station 106's current point of attachment, i.e., the care of address. For the duration of the registration, the routable address of the mobile station 106 is associated with its current care-of address. As a result, the local agent 108 forwards the data packets addressed to the routable address over to the care-of address.

The registration request message 402 includes a T bit 404 and an authenticator field 406. The T bit 404 is a single binary digit, which can be set to a numerical value ‘1’ by the mobile station 106, to request the local agent 108 to permit the creation of a reverse tunnel. In an embodiment of the present invention, the external agent 110 sets the T bit 404 to 1 when it detects that the mobile station 106 has not set the T bit 404 to 1. When the T bit 404 is not set to one then the reverse tunnel cannot be created. The authenticator field 406 in the registration request message 402 contains a digital signature associated with the registration request message 402. The receiver of the registration request message 402 will recalculate the digital signature using the mobile IP authentication key and compare that digital signature with the signature in the authenticator field to ensure the validity of the message. Hence, the registration request message is made in a format that is comprehensible to the local agent 108. The authenticator field 406 also contains a Security Parameter Index (SPI), which identifies a security context between the mobile station 106 and the local agent 108. The SPI includes the algorithm ID (e.g. MD5) used to calculate the digital signature. Any change in the registration request message 402 necessitates a change in the digital signature of the authenticator field 406 as well since the digital signature is calculated using the content of the registration request message 402.

Further, the registration request message 402 has an IP header 408. The IP header 408 includes a time-to-live field 410. The time-to-live field 410 determines a time limit, for which the registration request message 402 will be regarded as valid by the local agent 108. After expiration of the time limit specified in the time-to-live field 410, the registration request message 402 is considered to be invalid by the local agent 108. In an embodiment of the present invention, the external agent 110 sets the value of the time-to-live field 410 to 255, if it is not already set to 255 by the mobile station 106. The time-to-live field 410 is defined in RFC 3024.

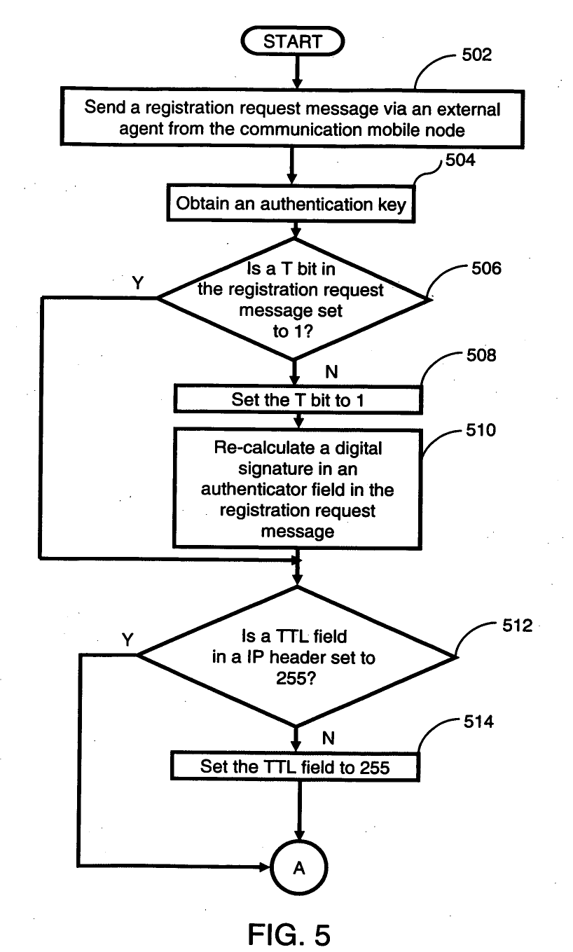

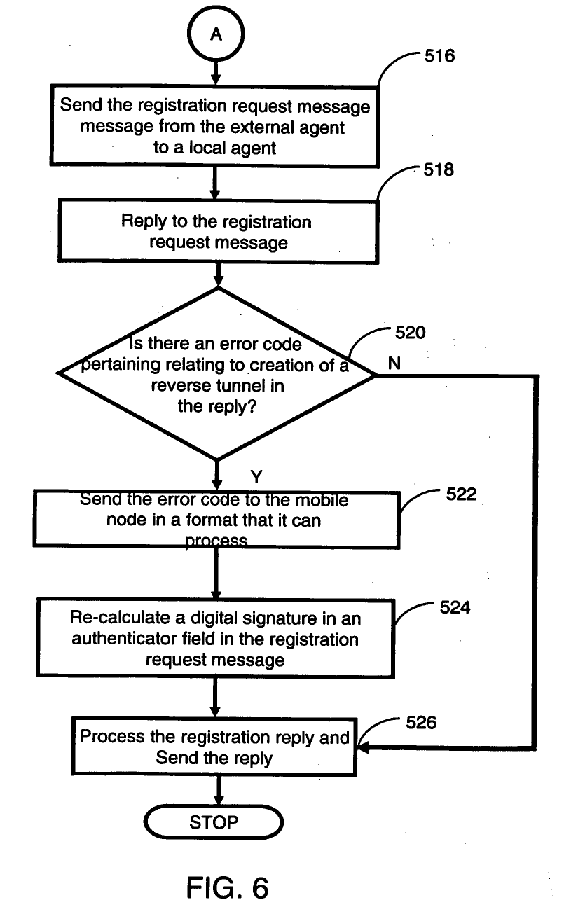

FIGS. 5 and 6 are exemplary process flow diagrams illustrating a method for communicating between mobile stations in accordance with one embodiment of the invention. At step 502, the mobile station 106 sends the registration request message 402 to the local agent 108 via the external agent 110. The registration request message 402 informs the local agent 108 of the care-of address of the mobile station 106. At step 504, the external agent 110 obtains an authentication key from an entity in the communication system 100. In one embodiment of the present invention, the external agent 110 obtains a Mobile IP authentication key from the entity. The entity can be any one from the local agent 108 or an AAA server of the local agent 108. In another embodiment of the present invention the external agent 110 obtains a Mobile IP authentication key from any other database containing the mobile IP authentication key. This operation can also be performed with the authentication of the mobile station 106 when it is entering a network monitored by the external agent 110.

At step 506, a check is made by the external agent 110 to verify if the T bit 404 in the registration request message 402 is set to 1. If the T bit 404 is not set to 1, the external agent 110 manipulates the registration request message 402. In one embodiment of the present invention, the external agent 110 sets the T bit 404 to 1, at step 508. Thereafter, at step 510, the external agent 110 recalculates the digital signature in the authenticator field 406, in the registration request message 402. The algorithm specified in SPI is used to recalculate the digital signature in the authenticator field 406. If the T bit 404 is already set to one, the external agent makes transitions from step 506 to step 512 directly. At step 512, a check is made to verify whether the time-to-live field 410 in the IP header 408 of the registration request message 402 is set to a value, such as 255. If the time-to-live field 410 is not set to the value, e.g. 255, the external agent 110 sets it to the value 255, at step 514. If the time-to-live field 410 is already set to 255, the local agent makes a transition to step 516 directly.

At step 516, the external agent 110 sends the registration request message 402 to the local agent 108. The local agent 108 processes the registration request message 402 and sends the reply for the registration request message 402 to the external agent 110, at step 518. Hence, the reply to the registration request message 402 reaches the external agent 110. At step 520, the external agent 110 checks if the reply contains any error message pertaining to the creation of the reverse tunnel. If there is an error message in the reply, the external agent 110 sends the error message to the mobile station 106 in a format that it can process, at step 522. Further at step 524, the external agent 110 recalculates the digital signature in the authenticator field 406, in the registration request message 402, as performed in the step 510. Finally the reply is sent at the step 526. If at step 520, there is no error code found then the method is directly terminated.

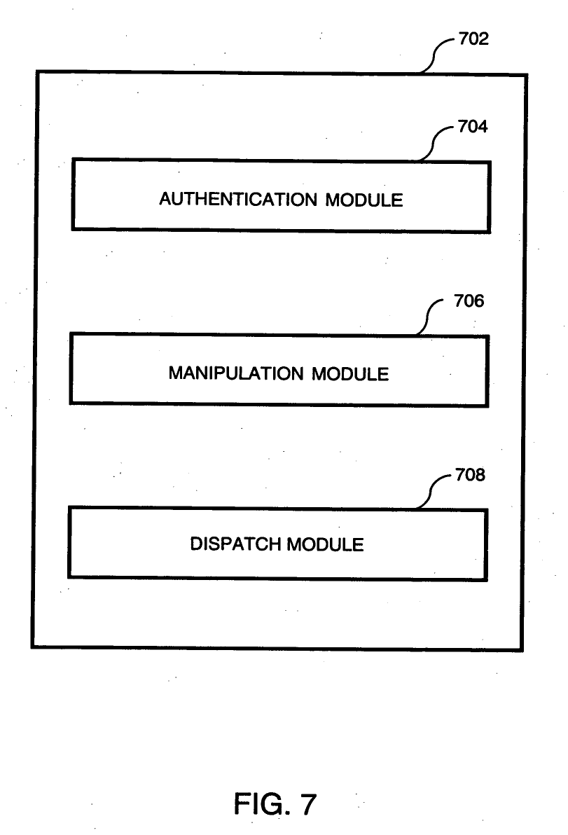

FIG. 7 represents a block diagram for an apparatus 702 for creating a reverse tunnel in a communication system, in accordance with an embodiment of the present invention. The apparatus 702 includes an authentication module 704, a manipulation module 706 and a dispatch module 708. The authentication module 704 obtains an authentication key from an entity in the communication system. In an embodiment of the present invention, the apparatus further includes an address assignment module for assigning an address to a mobile station. The manipulation module 706 manipulates a registration request message sent by a mobile station to the local agent and recalculates the digital signature of the modified message using the authentication key. The manipulation module 706 sets a T bit in the registration request message to a pre-defined value, if the mobile station has not set the T bit to the pre-defined value. Further, the manipulation module 706 also sets a bit-field in a header of the registration request message to a pre-determined value, if the mobile station has not set the bit-field to the pre-determined value. The manipulation module 706 further regenerates the digital signature in the authenticator filed in the registration request message. The dispatch 708 sends the registration request message from the external agent to the local agent. The apparatus further includes a reply module and a conversion module. The reply module sends a reply to the registration request message. The conversion module translates an error code contained in the reply to a format that can be processed by the mobile station.

The current invention provides several advantages. It solves the problems of ingress filtering and limited private address scenario, by providing a method to transfer data from a mobile station to a local agent for legacy mobile stations which cannot request for a reverse tunnel. It resolves the deployment issue of upgrading or recalling existing legacy mobile stations, which cannot request for a reverse tunnel. Instead of modifying the mobile stations, the changes are made to the local agents and the external agents. This is a more cost effective solution and has a shorter time to market.

It will be appreciated that embodiments of the invention described herein may be comprised of one or more conventional processors and unique stored program instructions that control the one or more processors to implement, in conjunction with certain non-processor circuits, some, most, or all of the functions of communication between mobile stations described herein. The non-processor circuits may include, but are not limited to, a radio receiver, a radio transmitter, signal drivers, clock circuits, power source circuits, and user input devices. As such, these functions may be interpreted as steps of a method to perform communication between mobile stations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for creating a reverse tunnel in a communication system, the communication system comprising at least one mobile station and a plurality of networks, the reverse tunnel being created from an external agent in a second network of the communication system to a local agent of a first network of the communication system, the method comprising:
obtaining an authentication key from an entity in the communication system;
manipulating, at the external agent, a registration request message sent by a mobile station to the local agent, and re-calculating a digital signature of a modified registration request message using the authentication key; and
sending the registration request message from the external agent to the local agent for creating the reverse tunnel.

2. The method of claim 1, wherein the entity is the local agent.

3. The method of claim 1, wherein the entity is an AAA server.

4. The method of claim 1, wherein the reverse tunnel is created based on the implementation of ingress filtering in the communication system.

5. The method of claim 1, wherein manipulating the registration request message comprises setting a T bit in the registration request message to a pre-defined value, if the mobile station has not set the T bit to the pre-defined value.

6. The method of claim 5, further comprising manipulating the registration request message by setting a bit-field in a header of the registration request message to a pre-determined value, if the mobile station has not set the bit-field to a pre-determined value.

7. The method of claim 5, further comprising manipulating the registration request message by regenerating an authenticator field in the registration request message.

8. The method of claim 1, further comprising authenticating the mobile node, wherein the authentication is performed by the external agent.

9. The method of claim 1, further comprising assigning an address to the mobile station by a local agent.

10. The method of claim 1, further comprising sending a reply for the registration request message.

11. The method of claim 10, wherein sending a reply comprises the foreign agent translating an error code contained in the reply to a format that can be processed by the mobile station.

12. The method of claim 11, wherein the error code pertains to the construction of the reverse tunnel.

13. A system for creating a reverse tunnel in a communication system, the communication system comprising at least one mobile station and a plurality of networks, the reverse tunnel being created from an external agent in a second network of the communication system to a local agent of a first network of the communication system, the system comprising:
a local agent for assigning an address to a mobile station; and
an external agent for setting at least one bit in a registration request message and regenerating an authenticator field in the registration request message accordingly.

14. The system of claim 13, wherein the local agent further comprises a reply module for replying the registration request message.

15. The system of claim 13, wherein the external agent further comprises an authentication module for obtaining an authentication key.

16. The system of claim 15, wherein the external agent obtains the authentication key from the local agent.

17. The system of claim 15, wherein the external agent obtains the authentication key from at least one of an AAA server and any other server containing the authentication key.

18. The system of claim 13, wherein the external agent further comprises a conversion module for translating an error code, the error code pertaining to the construction of the reverse tunnel, contained in the reply to a format that can be processed by the mobile station.

19. The system of claim 13, wherein the external agent further comprises a verification module for authenticating the mobile station.

20. An apparatus for creating a reverse tunnel in a communication system, the communication system comprising at least one mobile station and a plurality of networks, the reverse tunnel being created from an external agent in a second network of the communication system to a local agent of a first network of the communication system, the apparatus comprising:
an authentication module for obtaining an authentication key from an entity in the communication system;
a manipulation module for manipulating a registration request message sent by a mobile station to the local agent, and re-calculating a digital signature of a modified registration request message using the authentication key; and
a dispatch module for sending the registration request message from the external agent to the local agent.

21. The apparatus of claim 20, wherein the manipulation module performing setting a T bit in the registration request message to a pre-defined value, if the mobile station has not set the T bit to the pre-defined value.

22. The apparatus of claim 21, wherein the manipulation module further performing manipulating the registration request message by setting a bit-field in a header of the registration request message to a pre-determined value, if the mobile station has not set the bit-field to the pre-determined value.

23. The apparatus of claim 21, wherein the manipulation module further performing manipulating the registration request message by regenerating a digital signature in an authenticator field in the registration request message.

24. The apparatus according to claim 20, further comprising an address assignment module in a local agent for assigning an address to the mobile station.

25. The apparatus according to claim 20, further comprising a reply module for sending a reply for the registration request message.

26. The apparatus according to claim 20, further comprising a conversion module for translating an error code contained in a reply to a format that can be processed by the mobile station.
